(19) United States
(12) Patent Application Publication
(10) Pub. No.: US 2011/0241614 A1
(43) Pub. Date: Oct. 6, 2011

(54) Notebook capable of wireless charging

(75) Inventor: Ming-Hsiang Yeh, Taipei City (TW)

(73) Assignee: Winharbor Technology Co., Ltd., New Taipei City (TW)

(21) Appl. No.: 13/064,283

(22) Filed: Mar. 16, 2011

(30) Foreign Application Priority Data
Mar. 30, 2010 (TW) 099205513

(51) Int. Cl. H02J 7/00

(52) U.S. Cl. 320/108

(57) ABSTRACT

A notebook capable of wireless charging has a main body including a sensing element with a transmitter circuit. An electronic device with a receiver circuit to be charged is positioned on the sensing element. The transmitter circuit is configured to send an AC signal in a wireless way to the receiver circuit for charging a rechargeable battery of the receiver circuit. Thereby, various electronic products can be charged simultaneously without using different dedicated chargers. Also the limitation caused to the practical use of the notebook by wired charging through a charger can be eliminated.

### FIELD OF THE INVENTION

The present invention relates to a charging device, and more particularly to a charging device applicable to notebooks and the like.

### BACKGROUND OF THE INVENTION

Recently, with the ongoing improvement of science and technologies, people have required more and more from electronic products, particularly consumer electronics. The ancient, bulky electronic products (such as CD players, telephone sets and desktop computers) have been compacted into portable, efficient electronic products (such as multimedia players (MPEG Audio Layer-3, MP3), mobile phones and notebooks), for allowing people to live and work more efficiently.

These electronic products such as multimedia players and mobile phones are typically powered by rechargeable batteries such as Ni-MH batteries or lithium cells. Such a rechargeable battery can get charged by a charging device that includes a charging dock and a plug connected in a wired manner. The charging dock has a socket for receiving the rechargeable battery, while the plug is coupled to a power outlet for receiving a voltage or current, thereby charging the battery. On the other hand, a notebook to be powered or recharged has to be connected to a power outlet through an adapter that adapts a power outlet's voltage or current to the notebook. As the foregoing portable electronic products are all powered through adapters or rechargeable batteries, people going out with these portable electronic products have to carry their dedicated adapters or chargers as well, thus being greatly inconvenient. In addition, since the charging devices or adapters as mentioned above charge the rechargeable batteries in a wired mariner, such a wired deployment significantly limits the charging operation.

In view of this, the inventor of the present invention has spent contemplation in research, design and fabrication with the attempt to provide a notebook capable of wireless charging that is highly portable with reduced limitation with respect to its charging operation.

### SUMMARY OF THE INVENTION

A primary objective of the present invention is to provide a notebook capable of wireless charging, which allows various electronic products to be charged without their dedicated chargers.

Another objective of the present invention is to provide a notebook capable of wireless charging, which is configured to charge wirelessly so as to eliminate the limitation with respect to its charging operation.

To achieve the above objectives, the disclosed notebook capable of wireless charging is for coupling at least one electronic device. The electronic device has a receiver circuit. The notebook capable of wireless charging comprises a main body having a power source and a sensing element, on which sensing element the electronic device is positioned; and at least one transmitter circuit provided in the sensing element. The power source provides electric power to the transmitter circuit. The electric power is converted into the AC signal by the transmitter circuit. The AC signal is then sent to the receiver circuit of the electronic device through the transmitter circuit in a wireless manner. The receiver circuit at last converts the AC signal into electric power for charging. Thereby, various electronic products can be charged simultaneously without using different dedicated chargers. Also the limitation caused to the practical use of the notebook by wired charging through a charger can be eliminated, in turn improving the convenience in use.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic perspective view of a notebook capable of wireless charging according to a first embodiment of the present invention;

FIG. 2 is an applied view of the notebook capable of wireless charging according to the first embodiment of the present invention;

FIG. 3 is a block diagram illustrating the configuration of the notebook capable of wireless charging according to the first embodiment of the present invention;

FIG. 4 is a schematic perspective view of a notebook capable of wireless charging according to a second embodiment of the present invention; and

FIG. 5 is an applied view of the notebook capable of wireless charging according to the second embodiment of the present invention.

### DETAILED DESCRIPTION OF THE PREFERRED EMBODIMENTS

### First Embodiment

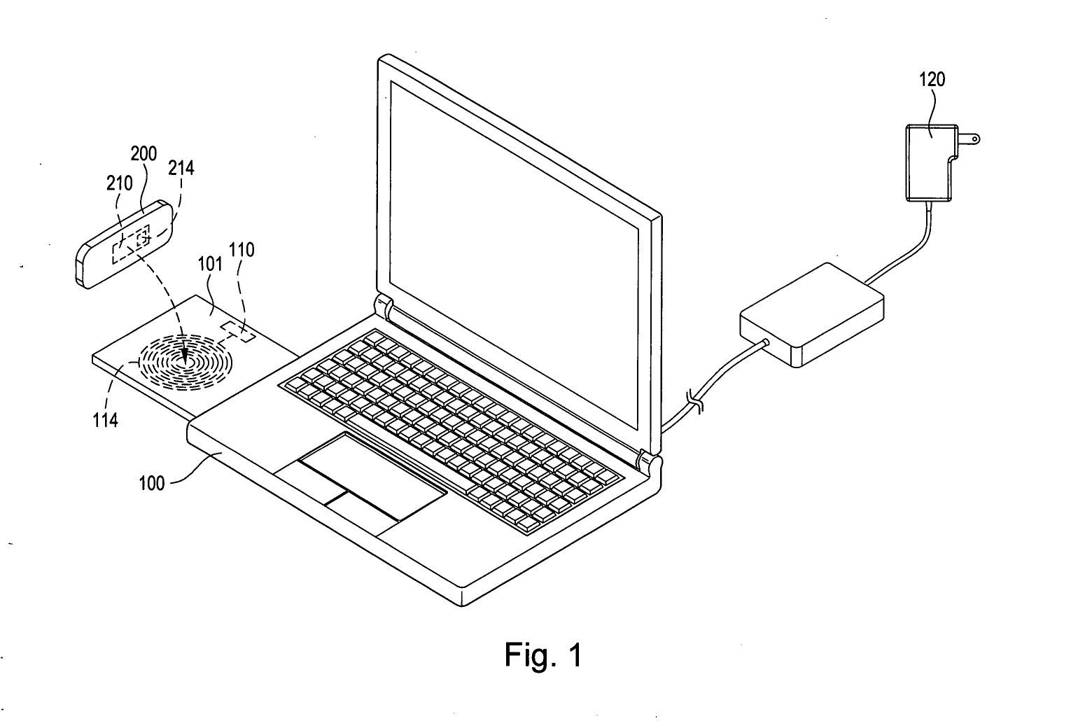

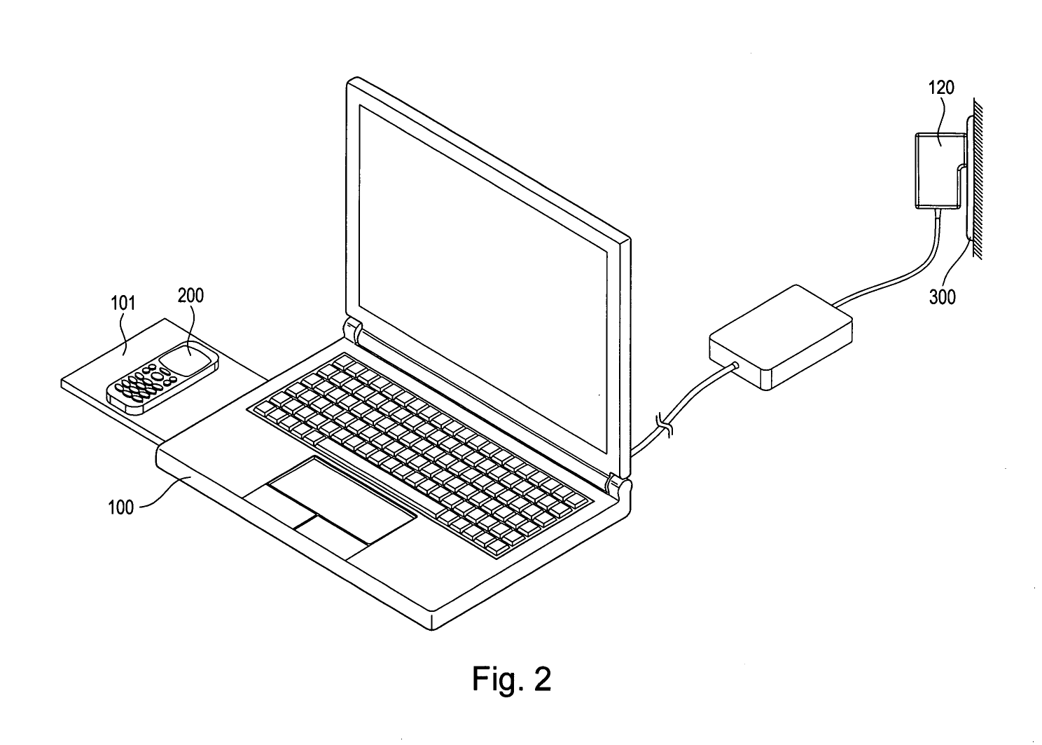

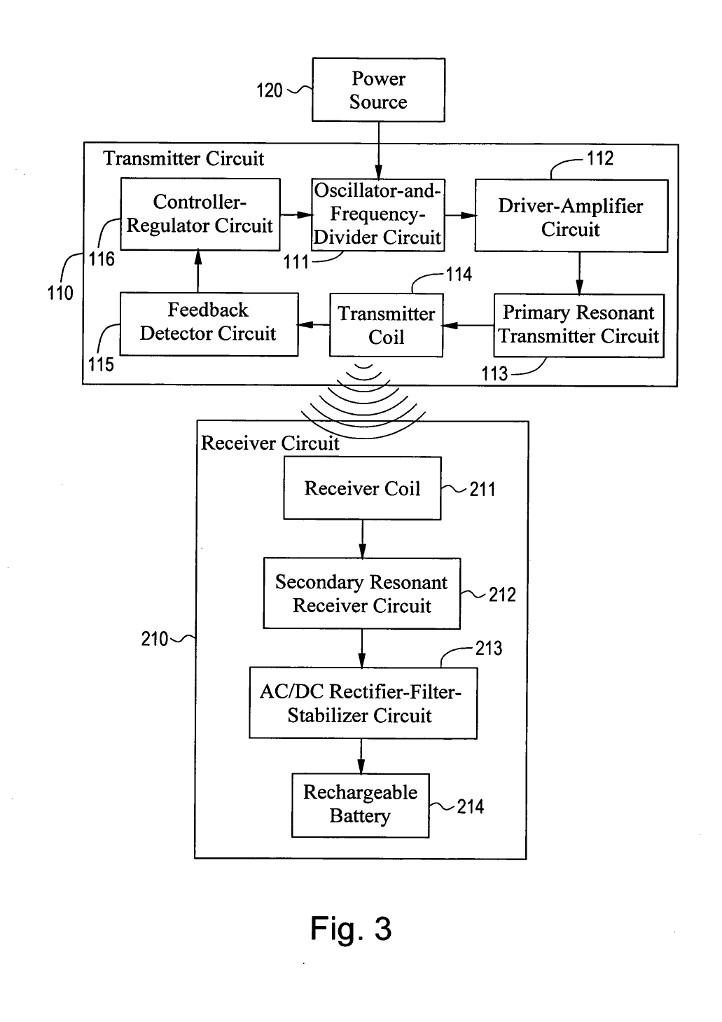

Referring to FIGS. 1 through 3, a notebook capable of wireless charging according to a first embodiment of the present invention is depicted in a schematic perspective view, an applied view and a block diagram. The notebook capable of wireless charging has a main body 100 provided with a transmitter circuit 110. A user may place an electronic device 200 that has a receiver circuit 210 on the main body 100 at will, for allowing charging in a wireless manner.

The main body 100 is the notebook including a power source 120 and provided with a sensing element 101. The sensing element 101 may be deposited on a disc tray, a touch pad, a top cover, a back cover or any portion of the main body 100. The transmitter circuit 110 coupled with the sensing element 101 allows the power source 120 to provide electric power to the transmitter circuit 110. The electric power is converted into the AC signal by the transmitter circuit 110. Then the AC signal is sent to the receiver circuit 210 of the electronic device 200 through the transmitter circuit 110 in a wireless way, so that the receiver circuit 210 can convert the AC signal into electric power that is stored and supplied to the electronic device 200.

The transmitter circuit 110 comprises an oscillator-and-frequency-divider circuit 111 connected to the power source 120, a driver-amplifier circuit 112 connected to the oscillator-and-frequency-divider circuit 111, a primary resonant transmitter circuit 113 connected to the driver-amplifier circuit 112 and a transmitter coil 114 connected to the primary resonant transmitter circuit 113. Thereby, the oscillator-and-frequency-divider circuit 111 converts the electric power provided by the power source 120 into the AC signal. The AC signal is amplified by the driver-amplifier circuit 112. The primary resonant transmitter circuit 113 resonates the amplified AC signal, and then the transmitter coil 114 sends it to the receiver circuit 210.

In addition, the transmitter circuit 110 may include a feedback detector circuit 115 connected to the transmitter coil 114 and include a controller-regulator circuit 116 connected to the feedback detector circuit 115 as well as the oscillator-and-frequency-divider circuit 111. The feedback detector circuit 115 feeds the AC signal coming from the transmitter coil 114 back to the controller-regulator circuit 116 to make the controller-regulator circuit 116 adjust an oscillation frequency of the oscillator-and-frequency-divider circuit 111, thereby optimizing the resonance.

The electronic device 200 may be a portable electronic product, such as a multimedia player or a mobile phone. The receiver circuit 210 on the electronic device 200 comprises a receiver coil 211, a secondary resonant receiver circuit 212 connected to the receiver coil 211, an AC/DC rectifier-filter-stabilizer circuit 213 connected to the secondary resonant receiver circuit 212 and a rechargeable battery 214 connected to the AC/DC rectifier-filter-stabilizer circuit 213. Thereby, the receiver coil 211 receives the AC signal from the transmitter circuit 110. The secondary resonant receiver circuit 212 resonates the AC signal. The AC/DC rectifier-filter-stabilizer circuit 213 then rectifies and stabilizes the AC signal, so as to convert the AC signal into electric power. The electric power is stored in the rechargeable battery 214 before supplied to the electronic device 200.

In the present embodiment, the main body 100 is a notebook (NB) with the sensing element 101 having the transmitter circuit 110 mounted on its disk tray. To charge the electronic device 200 (e.g. a mobile phone), the electronic device 200 is positioned on the sensing element 101, and the power source 120 is coupled with a power outlet 300, so that the electric power provided by the power source 120 to the transmitter circuit 110 is converted into the AC signal by the transmitter circuit 110. Then the transmitter coil 114 of the transmitter circuit 110 sends the AC signal to the receiver circuit 210 of each said electronic device 200, thereby charging the rechargeable battery 214 of the receiver circuit 210, and in turn powering the electronic device 200. Thereby, various electronic products can be charged simultaneously without using different dedicated chargers. Also the limitation caused to the practical use of the notebook by wired charging through a charger can be eliminated, in turn improving the convenience in use.

### Second Embodiment

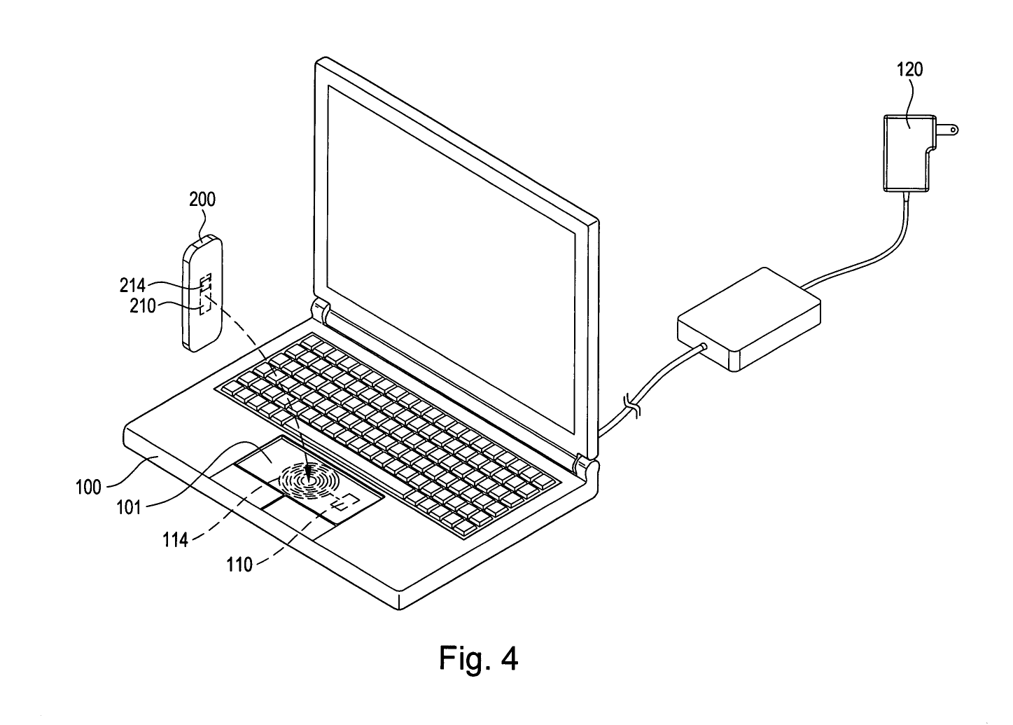

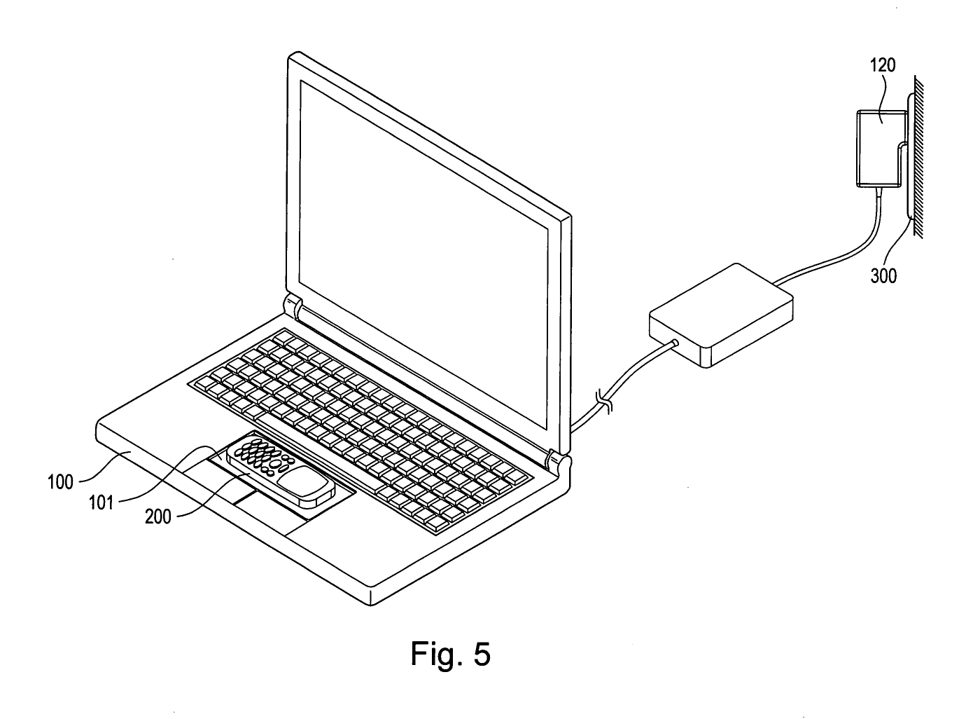

Referring to FIG. 4 and FIG. 5, a notebook capable of wireless charging according to a second embodiment of the present invention is depicted in a schematic perspective view and an applied view. The present embodiment is similar to the first embodiment, except that the sensing element 101 of the main body 100 is deposited on the touch panel of the main body 100. The electronic device 200 can be positioned on the sensing element 101 of the main body 100, so that each said electronic device 200 can be charged easily. When not used for charging, the touch pad retrieves its normal function of indication.

To sum up, the notebook capable of wireless charging as disclosed may have the sensing element 101 deposited at any portion of its main body 100 and features that the sensing element 101 has the transmitter circuit 110. When a user wants to charge an electronic device 200 with a receiver circuit 210, the user may position the electronic device 200 on the sensing element 101, so that the transmitter circuit 110 can send an AC signal to the receiver circuit 210 in a wireless manner, thereby charging the rechargeable battery 214 of the receiver circuit 210; so that electric power can be stored and provided to the electronic device 200. Thereby, various electronic products can be charged simultaneously without using different dedicated chargers. Also the limitation caused to the practical use of the notebook by wired charging through a charger can be eliminated, in turn improving the convenience in use.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A notebook capable of wireless charging for coupling and charging at least one electronic device, the electronic device having a receiver circuit, and the notebook capable of wireless charging comprising:
a main body including a power source and having a sensing element installed thereon, wherein the electronic device is positioned on the sensing element; and
at least one transmitter circuit mounted on the sensing element, the power source providing electric power to the transmitter circuit, the electric power being converted into the AC signal by the transmitter circuit, the AC signal being sent to the receiver circuit of the electronic device through the transmitter circuit in a wireless way, and the receiver circuit converting the AC signal into electric power for charging the electronic device.

2. The notebook capable of wireless charging of claim 1, wherein the main body is the notebook.

3. The notebook capable of wireless charging of claim 2, wherein the sensing element of the main body is deposited on a disc tray, a touch pad, a top cover or a back cover of the main body.

4. The notebook capable of wireless charging of claim 1, wherein the transmitter circuit includes an oscillator-and-frequency-divider circuit, a driver-amplifier circuit, a primary resonant transmitter circuit and a transmitter coil, the oscillator-and-frequency-divider circuit being connected to the power source and configured to convert the electric power provided by the power source into the AC signal, the driver-amplifier circuit being connected to the oscillator-and-frequency-divider circuit and configured to amplify the AC signal coming from the oscillator-and-frequency-divider circuit, the primary resonant transmitter circuit being connected to the driver-amplifier circuit and configured to resonate the AC signal amplified by the driver-amplifier circuit, the transmitter coil being connected to the primary resonant transmitter circuit and configured to send the resonated AC signal coming from the primary resonant transmitter circuit to the receiver circuit.

5. The notebook capable of wireless charging of claim 4, wherein the transmitter circuit further comprises a feedback detector circuit and a controller-regulator circuit, the feedback detector circuit being connected to the transmitter coil, the controller-regulator circuit connected to the feedback detector circuit and the oscillator-and-frequency-divider circuit, the feedback detector circuit feeding the AC signal coming from the transmitter coil back to the controller-regulator circuit, and the controller-regulator circuit adjusting an oscillation frequency of the oscillator-and-frequency-divider circuit.

6. The notebook capable of wireless charging of claim 1, wherein the receiver circuit comprises a receiver coil, a secondary resonant receiver circuit, an AC/DC rectifier-filter-stabilizer circuit and a rechargeable battery, the receiver coil receiving the AC signal coming from the transmitter circuit, the secondary resonant receiver circuit being connected to the receiver coil and configured to resonate the AC signal received by the receiver coil, the AC/DC rectifier-filter-stabilizer circuit connected to the secondary resonant receiver circuit and configured to rectify and stabilize the resonated AC signal coming from the secondary resonant receiver circuit and convert the AC signal into electric power, the AC/DC rectifier-filter-stabilizer circuit being connected to the rechargeable battery, and the rechargeable battery storing the electric power converted by the AC/DC rectifier-filter-stabilizer circuit.
